(19) United States
(12) Patent Application Publication
(10) Pub. No.: US 2015/0142668 A1
(43) Pub. Date: May 21, 2015

(54) APPARATUS AND METHOD FOR USING A DEVICE CONFORMING TO A PAYMENT STANDARD FOR ACCESS CONTROL AND/OR SECURE DATA STORAGE

(71) Applicant: MASTERCARD INTERNATIONAL INCORPORATED, Purchase, NY (US)

(72) Inventors: MICHAEL C. WARD, ECTON (GB); PATRIK SMETS, NIJLEN (BE); DAVID A. ROBERTS, WARRINGTON (GB); DUNCAN GARRETT, LONDON (GB); JOHN BERIC, LONDON (GB); STUART MILLER, HITCHIN (GB)

(21) Appl. No.: 14/539,813

(22) Filed: Nov. 12, 2014

Related U.S. Application Data
(63) Continuation of application No. 11/875,026, filed on Oct. 19, 2007, now abandoned.

(51) Int. Cl. G06Q 20/38; G06Q 20/34

(52) U.S. Cl. CPC G06Q 20/3829; G06Q 20/341
USPC 705/67

(57) ABSTRACT

Secure establishment of a key associated with a first facility identifier is facilitated. The key is shared between a device and an operator of a first facility, via a public key management infrastructure of a payment system operating according to the payment standard, during a first transaction, substantially in accordance with the payment standard, between the device and the first facility. Controlling access to a first facility is facilitated, via the device, using the key associated with the first facility identifier, substantially without reference to an issuer of the device and substantially without use of asymmetric keys of the device, during a plurality of subsequent transactions, substantially in accordance with the payment standard, between the device and the first facility.

### CROSS-REFERENCE TO RELATED APPLICATIONS

This patent application is a continuation of U.S. patent application Ser. No. 11/875,026 filed Oct. 19, 2007 entitled “APPARATUS AND METHOD FOR USING A DEVICE CONFORMING TO A PAYMENT STANDARD FOR ACCESS CONTROL AND/OR SECURE DATA STORAGE.” The complete disclosure of the aforementioned U.S. patent application Ser. No. 11/875,026 is expressly incorporated herein by reference in its entirety for all purposes.

### FIELD OF THE INVENTION

The present invention relates generally to the electronic and computer arts, and, more particularly, to apparatus and methods for electronic payment and/or access control.

### BACKGROUND OF THE INVENTION

Devices, such as electronic devices, and particularly electronic payment devices (for example, so-called “smart cards”) may be useful for a variety of payment and other applications, including controlling access to facilities such as transit systems and the like. One example of a smart card is a card compliant with the PAYPASS® M/CHIP® standard (registered marks of MasterCard International Incorporated, Purchase, N.Y. USA). Payment devices complaint with the PAYPASS M/CHIP® standard, depending on how they are used, may take approximately 350-500 ms to perform a transaction.

The transit marketplace generally requires fairly quick transaction times (for example, less than about 300 ms). Where a number of passengers are on line attempting to access a transit system (for example, a subway, underground, or metro system where access is controlled by turnstiles or wickets), a long transaction time may cause undesirable delays, excessive line (queue) length, customer dissatisfaction, and so on.

Typically, large transit agencies such as those in New York or London have one billion journeys per year. In the case of London, each journey requires presentation of a fare card on both entrance and exit.

### SUMMARY OF THE INVENTION

Principles of the invention provide techniques for using a device conforming to a payment standard to control facility access; further, in some instances, a stored session key can also be used to secure data storage, for example for confidentiality or integrity. An exemplary embodiment of a method (which can be computer-implemented), according to one aspect of the invention, includes the step of facilitating secure establishment of a key associated with a first facility identifier, shared between the device and an operator of the first facility, via a public key management infrastructure of a payment system operating according to the payment standard, during a first transaction, substantially in accordance with the payment standard, between the device and the first facility. The method also includes the step of facilitating controlling access to the first facility, via the device, using the key associated with the first facility identifier, substantially without reference to an issuer of the device and substantially without use of asymmetric keys of the device, during a plurality of subsequent transactions, substantially in accordance with the payment standard, between the device and the first facility. The steps can be repeated for a number of different facilities, such as different transit systems, with appropriate rules to address a situation where the device has a limited storage capacity for keys of different transit operators.

An exemplary embodiment of an apparatus (for example, a terminal and/or a payment card or similar device), according to another aspect of the invention, can include a memory and at least one processor coupled to the memory. The processor can be operative to perform and/or facilitate performance of one or more of the method steps described herein. In another aspect, the apparatus can comprise means for performing and/or facilitating performance of the various method steps. The means can include one or more hardware modules, one or more software modules, or a mixture of one or more software modules and one or more hardware modules. As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. One or more method steps of the invention can be implemented in the form of an article of manufacture comprising a machine readable medium that contains one or more programs that when executed implement such step or steps.

One or more techniques of the invention can provide one or more of the following substantial beneficial technical effects. These can include, for example, securely picking up the keys for each transit operator “on the fly” upon the first presentation of a card or other device to that operator, reduced transaction time, simpler transactions, potential use with multiple transit agencies (or similar facilities) without conflict, ease of implementing a distance bounding algorithm to check for man-in-the middle fraud attacks, no need to personalize secret keys a priori, efficient and simplified management, easy re-establishment of lost keys, simplified confidentiality mechanisms for transit operators, simplified data integrity for transit operators, and operator-specific data storage. These and other features and advantages of the invention will become apparent from the following detailed description of illustrative embodiments thereof, which is to be read in connection with the accompanying drawings.

### BRIEF DESCRIPTION OF THE DRAWINGS

FIG. 1 shows an example of a system and various components thereof that can implement techniques of the invention;

FIG. 2 shows one specific exemplary application of inventive techniques to control access to a transit system;

FIG. 3 is a flow diagram showing one specific exemplary manner in which a conventional transaction flow according to the PAYPASS® M/CHIP® standard can be modified according to exemplary inventive techniques;

FIG. 4 is a specific exemplary flowchart showing an exemplary transaction flow according to an aspect of the invention; and

FIG. 5 is a block diagram of an exemplary computer system useful in one or more embodiments of the invention.

### DETAILED DESCRIPTION OF PREFERRED EMBODIMENTS

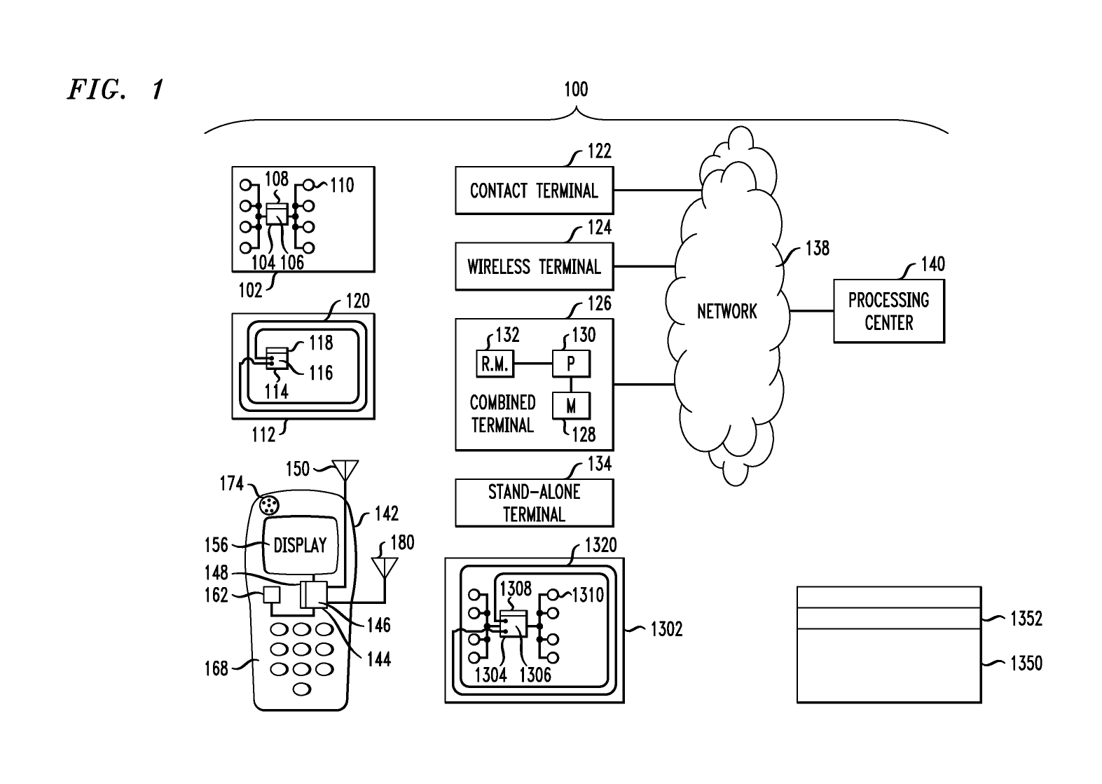

Attention should now be given to FIG. 1, which depicts an exemplary embodiment of a system 100 together with various possible components of the system. System 100 can implement inventive techniques, and can include one or more different types of portable payment devices. For example, one such device can be a contact device such as card 102. Card 102 can include an integrated circuit (IC) chip 104 having a processor portion 106 and a memory portion 108. A plurality of electrical contacts 110 can be provided for communication purposes. In addition to or instead of card 102, system 100 can also be designed to work with a contactless device such as card 112. Card 112 can include an IC chip 114 having a processor portion 116 and a memory portion 118. An antenna 120 can be provided for contactless communication, such as, for example, using radio frequency (RF) electromagnetic waves. An oscillator or oscillators, and/or additional appropriate circuitry for one or more of modulation, demodulation, downconversion, and the like can be provided. Note that cards 102, 112 are exemplary of a variety of devices that can be employed with techniques of the invention. In one or more embodiments of the invention, a dual-interface device 1302 is employed. Device 1302 is shown larger than devices 102, 112 for illustrative convenience but can have a similar form factor. Device 1302 includes an IC chip 1304 having a processor portion 1306 and a memory portion 1308. A plurality of electrical contacts 1310, similar to contacts 110, can be provided, as well as an antenna 1320 similar to antenna 120, together with an oscillator or oscillators, and/or additional appropriate circuitry for one or more of modulation, demodulation, downconversion, and the like, as described with regard to device 112. Appropriate firmware to manage the two available interfaces can be provided, with operation otherwise being similar to devices 102, 112. The description of devices, elements, or components 102, 104, 106, 108, 110, 112, 114, 116, 118, 120 throughout this document are equally applicable to the corresponding items 1302, 1304, 1306, 1308, 1310, 1320. Memories 108, 118, 148 (discussed below) and 1308 may further be divided into non-volatile and volatile memory.

The ICs 104, 114 can contain processing units 106, 116 and memory units 108, 118. Preferably, the ICs 104, 114 can also include one or more of control logic, a timer, and input/output ports. Such elements are well known in the IC art and are not separately illustrated. One or both of the ICs 104, 114 can also include a co-processor, again, well-known and not separately illustrated. The control logic can provide, in conjunction with processing units 106, 116, the control necessary to handle communications between memory unit 108, 118 and the input/output ports. The timer can provide a timing reference signal from processing units 106, 116 and the control logic. The co-processor could provide the ability to perform complex computations in real time, such as those required by cryptographic algorithms.

The memory portions or units 108, 118 may include different types of memory, such as volatile and non-volatile memory and read-only and programmable memory. The memory units can store transaction card data such as, for example, a user's primary account number (“PAN”). The memory portions or units 108, 118 can store the operating system of the cards 102, 112. The operating system loads and executes applications and provides file management or other basic card services to the applications. In some embodiments, one or more applications may “sit” directly on hardware, that is, may be outside the domain of the operating system. One operating system that can be used to implement the invention is the MULTOS® operating system licensed by StepNexus Inc. Alternatively, JAVA CARD™ -based operating systems, based on JAVA CARD™ technology (licensed by Sun Microsystems, Inc., 4150 Network Circle, Santa Clara, Calif. 95054 USA), or proprietary operating systems available from a number of vendors, could be employed. Preferably, the operating system is stored in read-only memory (“ROM”) within memory portion 108, 118. In an alternate embodiment, flash memory or other non-volatile and/or volatile types of memory may also be used in the memory units 108, 118.

In addition to the basic services provided by the operating system, memory portions 108, 118 may also include one or more applications as described herein. At present, one preferred standard to which such applications may conform is the EMV payment standard set forth by EMVCo, LLC (http://www.emvco.com). It will be appreciated that, strictly speaking, the EMV standard defines the behavior of a terminal; however, the card can be configured to conform to such EMV-compliant terminal behavior and in such a sense is itself EMV-compliant. It will also be appreciated that applications in accordance with the invention can be configured in a variety of different ways.

As noted, cards 102, 112 are examples of a variety of payment devices that can be employed with techniques of the invention. The primary function of the payment devices may not be payment, for example, they may be cellular phone handsets, or access cards for a public transportation system, that implement techniques of the invention (in general terms, devices conforming to a payment standard). Such devices could include cards having a conventional form factor, smaller or larger cards, cards of different shape, key fobs, personal digital assistants (PDAs), appropriately configured cell phone handsets, or indeed any device with the processing and memory capabilities to implement techniques of the invention. The cards, or other payment devices, can include memories 108, 118 and processors 106, 116 coupled to the memories. Optionally, body portions (for example, laminated plastic layers of a payment card, case or cabinet of a PDA, chip packaging, and the like) are associated with memories 108, 118 and processors 106, 116. The memories 108, 118 can contain applications as described herein. The processors 106, 116 can be operative to execute one or more method steps to be described herein. The applications can be, for example, application identifiers (AIDs) linked to software code in the form of firmware plus data in a card memory such as an electrically erasable programmable read-only memory (EEPROM).

A number of different types of terminals can be employed with system 100. Such terminals can include a contact terminal 122 configured to interface with contact-type device 102, a wireless terminal 124 configured to interface with wireless device 112, or a combined terminal 126. Note that “contactless” and “wireless” are used in an interchangeable fashion herein and that the skilled artisan is familiar with the meaning of such terminology. Combined terminal 126 is designed to interface with either type of device 102, 112. Terminals may be contact terminals with plug-in contactless readers. Combined terminal 126 can include a memory 128, a processor portion 130, and a reader module 132. Note that the principles of construction of terminal 126 are applicable to other types of terminals and are described in detail for illustrative purposes. Reader module 132 can be configured for contact communication with card or device 102, or contactless communication with card or device 112, or both (different types of readers can be provided to interact with different types of cards for example, contacted or contactless). Terminals 122, 124, 126 can be connected to a processing center 140 via a computer network 138. Network 138 could include, for example, the Internet, or a proprietary network (for example, a virtual private network (VPN) such as the BANKNET® network (registered mark of MasterCard International Incorporated, Purchase, N.Y., USA)). Processing center 140 can include, for example, a host computer of an issuer of a payment device. One or more distinct networks can be employed. As discussed below, inventive terminals can have payment modules coupled to electronic merchandise modules; the modules can be implemented in software, firmware, and/or hardware. In one or more embodiments, the modules may be software modules running on the same processor.

Stand-alone terminal 134 is representative of a terminal that is not connected to a computer network (either not connected at a particular time, or not connected at all, by design), and is otherwise generally similar to the other terminals described.

An appropriately configured cellular telephone handset 142 can also be employed in system 100. Handset 142 is depicted in semi-schematic form in FIG. 1, and can include one or more IC chips such as chip 144 including a processing unit 146 and a memory unit 148. Wireless communication with a terminal can be provided via antenna 150 or with a second antenna 180 similar to above-described antenna 120 (that is, the handset could have a second antenna for the payment application). Note that antenna 180 is depicted schematically, but could be, for example, a coil antenna as used in a typical “smart” card. Handsets 142 can each be equipped with a suitable display 156. Further, an appropriate power supply 162 can also be provided. Such power supplies can include, for example, a battery and appropriate circuitry. The display and power supply can be interconnected with the processor portion. A keypad 168 can be provided. Element 174 is indicative of speaker and microphone elements that can be incorporated. Different types of portable payment devices can combine or “mix and match” one or more features depicted on the exemplary devices in FIG. 1.

In one aspect of the invention, an electronic payment device, which may be portable, is provided for facilitating transactions by a user with a terminal, such as 122, 124, 126, 134, of a system such as system 100. The device can include a processor, for example, the processing units 106, 116, 146 discussed above. The device can also include a memory, such as memory portions 108, 118, 148 discussed above, that is coupled to the processor. Further, the device can optionally include a communications module that is coupled to the processor and configured to interface with a terminal such as one of the terminals 122, 124, 126, 134. The communications module can include, for example, the contacts 110 or antennas 120, 150, 180 together with appropriate circuitry (such as the aforementioned oscillator or oscillators and related circuitry) that permits interfacing with the terminals via contact or wireless communication. The processor of the apparatus can be operable to perform one or more steps of methods and techniques described herein. The processor can perform such operations via hardware techniques, and/or under the influence of program instructions stored in one of the memory units. The portable device can include a body portion. For example, this could be a laminated plastic body (as discussed above) in the case of “smart” cards 102, 112, or the handset chassis and body in the case of handset 142.

It will be appreciated that the terminals 122, 124, 126, 134 are examples of terminal apparatuses for interacting with portable payment devices in accordance with one or more exemplary embodiments of the invention, and may include a processor such as processor 130, a memory such as memory 128 that is coupled to the processor, and a communications module such as 132 that is coupled to the processor and configured to interface with the portable apparatuses 102, 112, 142. The processor 130 can be operable to communicate with portable payment devices of a user via the communications module 132. The terminal apparatuses can function via hardware techniques in processor 130, or by program instructions stored in memory 128. Such logic could optionally be provided from a central location such as processing center 140 over network 138.

The above-described devices 102, 112 are preferably ISO 7816-compliant contact cards or devices or NFC (Near Field Communications) or ISO 14443-compliant proximity cards or devices. In operation, card 112 can be touched or tapped on the terminal 124 or 128, which then contactlessly transmits the electronic data to the proximity IC chip in the card 112 or other wireless device.

Some implementations may make use of a magnetic stripe (“mag stripe”) chip card 1350 with magnetic stripe 1352. Such a card may conform, for example, to ISO/IEC specification 7811/2, which addresses the recording of the magnetic stripe, and to specification 7810, which covers the physical characteristics. Magnetic stripe readers can be provided on any or all of the terminals 122, 124, 126, and 134. One example of such a magnetic stripe chip card is a MASTERCARD PAYPASS® magnetic (mag) stripe chip card (it should be noted that for use with one or more embodiments of the invention, a magnetic stripe chip card, and not merely a traditional card that only possesses embossing and a magnetic stripe, is required). Card 1350 can include an integrated circuit (IC) chip similar to chips 104, 114 having a processor portion similar to 106, 116 and a memory portion similar to 108, 118—these are omitted from FIG. 1 for illustrative convenience.

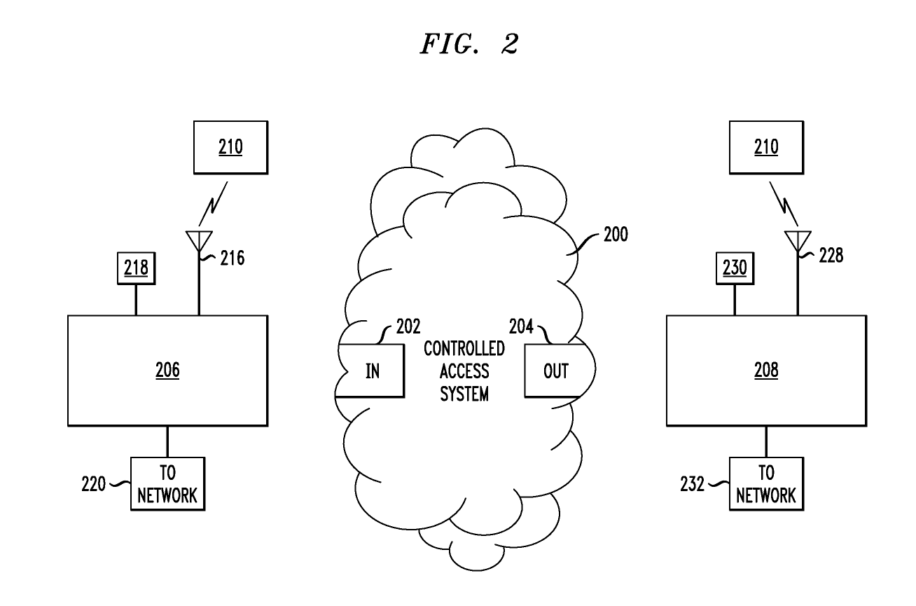

FIG. 2 shows an exemplary application of techniques of the invention to a controlled access system, in accordance with one aspect of the invention. The system 200 can be, for example, a transportation vehicle, a complete transportation infrastructure including one or more railroad stations or bus terminals, an amusement park, a museum, and the like. System 200 may have an entrance point 202 and an exit point 204. A first terminal 206 can be located adjacent entrance point 202 and a second terminal 208 can be located adjacent exit point 204. It will be appreciated that there may be multiple entry and exit points, and that each may be provided with an appropriate terminal. The terminals, such as terminal 206, can be configured for communication with an electronic payment device, such as device 210, which is configured according to a payment standard. The device 210 can be, for example, a contacted card, a contactless card, a cell phone, or other device as described above.

The terminal 206 can include an antenna 216 for contactless communication (appropriate modulation and conversion circuitry, well known in the art and similar to that discussed above, can also be included). Further, the payment module can include a reader for contacted cards, 218. Note that the reader 218 and antenna 216 can be separate entities or can be integrated with the terminal 206 as desired. Terminal 206 can have network connection 220. The connection can be to any type of network described above with regard to FIG. 1. Elements 228, 230, 232 of terminal 208 can function similarly to corresponding elements 216, 218, 220 of terminal 206.

By way of an example to aid understanding of the skilled artisan, one example of a payment standard is the EMV standard, which is implemented, for example, in a payments system incorporating EMV, such as that operated by MasterCard International Inc. in conjunction with Issuers, Acquirers, and Merchants.

Some systems, such as transit systems in London and in Washington, D.C., may read cards or other devices on both entrance (terminal 206) and exit (terminal 208), due to fares that depend on the distance traveled, while other systems, such as the New York subway, may charge a flat fare and only read cards or other devices on entrance (terminal 206).

It will be appreciated that when an EMV (or similar) transaction is made, and particularly when performed in a contactless manner, speed is significant, especially in transit applications. In some instances of the invention, it is desirable to reduce transaction times below 250 ms. Current PAYPASS M/CHIP® cards take up to 500 ms for a transaction. In one or more embodiments of the invention, we establish a symmetric key between the card (or other device) and a transit infrastructure (or other facility), then provide a quick way for the terminal to recognize the identity and the presence of the symmetric key. In one or more embodiments, this can result in substantial reductions in transaction times, for example, halving the transaction times. In addition, the inclusion of this key then means we have a ready means to store transit data securely on the card. The level of security offered to the terminal is similar to that obtained for “CDA” (combined dynamic data authentication/application cryptogram). In some instance, the card can have a small table of such keys which can be accepted by several different transit authorities at the same time without conflict. Finally, having such a key may also be of assistance in implementing a “distance bounding algorithm” to check for “man-in-the-middle” fraud attacks. A distance bound algorithm checks that the card and terminal are physically close to each other by “bounding” the distance apart that they are by measuring the time delays in communications. To work well, they need a symmetric key shared between card and terminal. The distance bounding algorithm is known in itself, but has experienced problem with getting a suitable shared key, and thus may be facilitated by one or more embodiments of the invention.

It should be noted that use of language such as “we” does not necessarily contemplate human agency, but should be construed to include steps performed in an automated fashion, by a computer or the like.

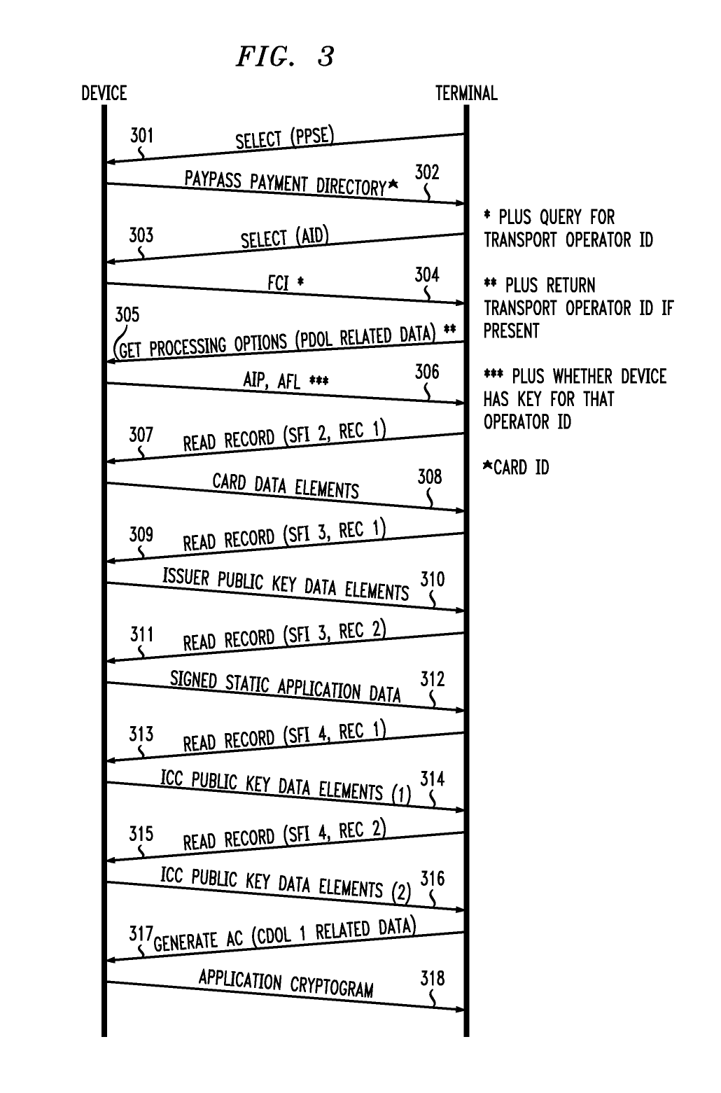

Giving attention now to FIG. 3, an example will be given of how a standard transaction can be modified in accordance with techniques of the invention. In a normal transaction, in a zeroth step (not illustrated), the terminal and card (understood to include other kinds of devices, as well), establish communications. In a first step 301, the SELECT (PPSE) command allows the terminal to find out what payment applications the card has. This information is returned in the PAYPASS PAYMENT DIRECTORY in step 302. In step 303, the terminal selects an appropriate one of the applications using the SELECT command with the appropriate application identifier (AID) as an argument. Step 304 includes the return of information (described above) from selecting PPSE. Step 306 includes the card responding to the select application command telling it the information that it needs for the transaction—AIP tells it how to conduct the transaction, while AFL tells it what records need to be read from the card in order to do it. It may also specify something called the PDOL—Processing Data Objects List, which is data that the card needs from the terminal in order to conduct the transaction as defined immediately hereinafter for step 305. In step 305, if the card asked for any specific data in step 304, the terminal sends it in step 305, via the GET PROCESSING OPTIONS command. This step “says” to the card “tell me the basic context for the transaction. What do I need to read from you and what process shall we use?” The various commands and arguments are familiar to the skilled artisan from the EMV, PAYPASS® M/CHIP® & PAYPASS® MAGSTRIPE standards.

In steps 307 through 316, a large amount of data is read from the card, using a series of READ RECORD commands, in a manner well-known in the art. In step 317, the terminal asks the card to complete the transaction via a GENERATE AC command. In a conventional situation, one would obtain and use a certified copy of the card's keys from the READ RECORDS, then ask the card to sign the transaction in step 317, giving a signature over the transaction data in step 318 that the terminal can check.

The conventional process just described will now be reiterated and summarized. There is an initial exchange where the card and terminal work out how to communicate and establish communication. This process is different depending on whether the card is contacted or contactless, but the skilled artisan can readily adapt inventive techniques to either case, given the teachings herein. Then, the application is selected at 303, wherein a “SELECT” command is sent from the terminal to the card, giving the card the identity of the application the terminal wants to select. The terminal gets a response from the card at block 304 that says (the terms “say,” “talk,” and the like being understood to contemplate electronic communication), in essence, “here is a brief description of the card.” The terminal then sends the “GET PROCESSING OPTIONS” command to the card in step 305. This is, in colloquial terms, the terminal saying to the card “I would like to conduct a transaction; let us work out the details of how we should proceed”; the terminal says to the card “if you asked for any details to determine how we should communicate, here are those details,” and the card says to the terminal, in step 306, “here is the information that you need in order to know how to proceed with the transaction.” The information basically tells the terminal what to read from the card and what the context of the transaction is-how to authenticate the card, whether the terminal should perform risk management, and so on.

In steps 307-316, the terminal takes from the card all of the information it needs, via a series of instructions called “READ RECORD.” These instructions typically take a fair amount of time. The data obtained includes the primary account number (PAN), expiry date, track data, and a series of RSA certificates that allow the terminal to verify the authenticity of the card's data. At this point, the terminal does not yet know that the card has not been skimmed (card data illicitly captured in some form of card reader), but the terminal does know that it now has a set of data that it understands, and a certificate for a set of card keys. The terminal loads the data that has been obtained from the card into memory. Then the terminal ‘says’ “I'll check the data obtained from the card, perform terminal risk management, and if everything appears to be in order, I'll ask the card to complete the transaction by giving the card a ‘genAC’ command (generate application cryptogram).”

At this stage, the card performs card risk management. The card has been told by the terminal, for example, “I would like to a conduct a transaction for $27 US and my terminal ID is (a given value) and here is/are the results of my risk management, and so on.” The card examines this data and examines its own limits and decides whether it is appropriate to complete the transaction, and if so, generates a transaction certificate (a message that the card's issuer understands), protected by a MAC (message authentication code)—an eight byte value that the issuer can check that indicates this is a proper transaction. The terminal can't understand the MAC because it does not have a key, so we need to tell the terminal that it is authentic data. Thus, we take the data that the issuer understands and sign it with RSA and the terminal can check the resulting signature, because it obtained a certificate for the card's keys from the card during the READ RECORDS (referred to as CDA (combined data authentication)). In effect, the terminal and card have started communicating, established a context, the terminal obtained a significant amount of data from the card and “said” to the card “I would like to complete the transaction, here is the value of the transaction, and I would like you to sign the response so that I can check that it is authentic.” Then, the terminal sends that response over a payment network, such as the MasterCard BANKNET® network, to the issuer (typically, at some later point).

The prior art approach requires a long time to perform the READ RECORDS. Further, in conventional techniques, it takes a long time for the card to perform the RSA signature on the genAC. About 300 ms out of a total of 500 ms are used to do these two things.

An exemplary inventive modification of the above process will now be described. In step 304, as indicated by the asterisk, the card asks the terminal for its transport operator ID. If the terminal has one, it tells the card in step 305, as indicated by the double asterisk. In step 306, if the terminal provided an operator ID to the card, the card tells the terminal if it already has a key for that operator ID, as indicated by the triple asterisk. If the card does not have such an ID (for example, card has never been used in that system before, or was used previously but has had the key overwritten), we continue with steps 307-316 and then we encrypt a symmetric key with the card's public key and send it to the card between steps 316 and 317.

If the card does have such a key, we skip steps 307-316. We then perform steps 317 and 318, but instead of asking for an RSA signature (CDA), we ask the card for a MAC, using the key the terminal just gave to the card. Finally, it should be noted that in this approach, in step 302, the card provides the terminal a card ID, as indicated by the single star, so the terminal knows “who” the card is, without the need to perform steps 307-308. In one or more alternative approaches, we may also provide the ID in step 306 or may allow the terminal to perform one of the READ RECORDS and obtain the ID.

Note that subsequent transactions (after first presentation of the card in the system, when it acquires the key associated with the transport operator ID) therefore perform steps 301-306 and 317-318 using the symmetric key MAC instead of the RSA signature. Skipping steps 307-316 saves, in one or more embodiments, about 100 ms, while skipping the RSA saves, in one or more embodiments, about 200 ms, in an overall budget of, for example, about 500 ms. Initial transactions (before the key is acquired) are typically no slower than a normal retail point of sale transaction.

The inventive modification of the process will now be reiterated and summarized. Suppose we established a key with the card. A transport operator can say to the card, “here is a key—when you (the card) generate the transaction cryptogram (MAC) for the issuer, put another MAC around it with my key (that is, the transit operator's key) so I can check it and know it is authentic before I send it to the issuer.” For this approach to work, the transport operator should be sure that the key is only handed over to authentic cards. Thus, the certificates and the keys in the READ RECORD can be re-used, and instead of the card using the payment system's card private key to sign the transaction certificate in the genAC, the process essentially proceeds the other way around. The payment system's card public key is used to encrypt a transit operator's symmetric key that is given to the card and the card decrypts it with the payment system's card private key.

If the transport operator is confident that only the card knows the corresponding private (secret) key, the operator can be confident that only the authentic card could know the symmetric key the operator has given it. Thus, if it knows that is an authentic key, it can confidently encrypt the symmetric key, give it to the card, the card can store it, and the card can prove that is has got the right key by MAC-ing the transaction certificate (TC) returned in the genAC command and giving it back. Accordingly, we have a way to re-use the keys in the opposite direction to normal to give a key to the card that the card can use to “MAC” a transaction and give it back to the terminal. Because RSA is no longer required, we have an immediate saving of about 200 ms on subsequent transactions (but have, in one view, a 200 ms penalty on the first transaction with a given operator, although this is effectively just the same as if a conventional RSA transaction took place). Since there is no longer a need to read all the certificates in the card, because RSA is no longer used, all the READ RECORDS can be skipped. If the transport operator's terminal can be sure that the card has got a key, we can skip all the READ RECORDS and go straight to the genAC command, thus resulting in the other 100 ms of savings.

In essence, what has been done is to push right back into the start of the transaction, when the card and terminal establish the context, an interchange that tells the transit operator, “skip a number of steps as you've seen this card before and you know how to talk to this card because you have established a key with it.” Further, since, for example, a person using a card in New York may go to visit London, and it is advantageous that the card work the same way in London as in New York, we give each transport operator an identity and preferably construct the transaction flow such that every operator tells its identity to the card. The card can have a database of keys, and if it sees it already has a key for the given operator, it can send a response indicating same to the terminal, while if it does not have a key for that operator, it will indicate that as well, and initiate the key establishment process. In this way, the card can automatically pick up keys for all of the transport infrastructures that it uses around the world, limited only by how much memory it has. Appropriate memory management rules can be provided-for example, we can overwrite the oldest entry when we run out of memory. There is typically no need to have any keys established in personalization between the transport operator and bank (issuer)—all of this can be done on the fly, establishing the needed keys at that point in time. Thus, one or more embodiments simplify personalization problems that have occurred with prior-art schemes, because there is typically no need to personalize any secret keys for a transport operator.

In one or more embodiments, the card, between steps 305 and 306, is provided with a store for several transport operators. The card can therefore hold several keys corresponding to several transport operator IDs at the same time. If the card runs out of space, it can have appropriate logic to handle the situation, for example, by overwriting the key that was used least recently.

Furthermore, in one or more embodiments, there is no need to personalize secret keys a priori. In these particular instances, the only things that the terminal needs are: (i) a set of the payment system public keys (maximum of six per payment scheme) and (ii) confidence that if a card knows the secret keys that correspond to a signed public key, then it is genuine. We regard to point (i), in this approach, the terminal needs the payment system public keys in order to recover the issuer public key from the issuer certificates returned in the READ RECORD commands, and it needs the issuer public key to recover the card public key that it then uses to encrypt the transit operator symmetric key. It needs to trust the payment system key in order to be able to trust the authenticity of the card public key. EMV specifies that a terminal needs to have storage for up to 6 such payment system keys per payment scheme.

It should be noted that an advantage of one or more embodiments of the invention is that the symmetric key approach may assist data storage. A stored session key can be used to secure data storage, for example, for confidentiality or integrity as well as access control.

In one or more instances, including some basic management data, for example, a version number for each operator's symmetric key, allows the operator to manage their symmetric keys efficiently. The provision of such a version number helps the operator recognize when a card has an “old” or “expired” or “compromised” key and replace it with a new one by repeating the initial key establishment process. If a card is used widely and loses the stored key for a given transport operator, such can be easily re-established on the card by repeating the initial process as described with regard to FIG. 3 for the case where the card does not have a stored key for the particular transport operator (re-establishment includes putting the lost old key back or establishing a new one to replace it).

It will be appreciated that the same idea can also be used in a transaction with a magnetic stripe chip card, such as a MASTERCARD PAYPASS® magnetic stripe chip card (not a traditional card that only possesses embossing and a magnetic stripe). This is possible because the magnetic stripe chip card is still following a basic EMV transaction flow. The only difference is that such magnetic stripe cards do not carry RSA keys—this would need to be added.

Thus, in one or more embodiments of the invention, transaction times (after the initial presentation) can be reduced to just over about 200 ms, and key management can be substantially simplified. Further, functionality can be included in a smart card standard, such as the PAYPASS M/CHIP® standard, that supports multiple transit system operators concurrently without needing to establish symmetric keys or personalization in advance. The cardholder may take the card into different transit environments. There will be an initial transaction for each operator during which the card will acquire a key for that transit operator which it will then use to accelerate all the transactions after that and it will automatically reconfigure and adjust itself as it moves from transit operator to transit operator.

It will be appreciated that in one or more inventive instances, symmetric keys can be used to accelerate transactions. It would also be possible to use a symmetric key as an alternative to an offline encrypted PIN enciphered using RSA. Exemplary techniques have been disclosed herein, wherein a symmetric key is delivered to the card using the dynamic data authentication (DDA) key. This symmetric key is used to add an extra MAC to a genAC response. In one or more instances, the inclusion of an extra identity for the card (for example in a proximity payment systems environment (PPSE) removes the need to read any records in subsequent transactions. The initial key establishment transaction takes about the same time as a CDA normal transaction (roughly half a second for a good card) and subsequent transactions would take, for example, less than about 250 ms. In one or more embodiments, no shared keys are needed between merchants (such as transit system operators) and issuers, and a small table of keys in the card allows it to work in multiple locations. It is also possible to use a symmetric key or a session key derived from it to encipher all communications to a card to avoid passive eavesdropping, and it may also assist in creating a distance bounding algorithm for active attacks. The presence of a symmetric key shared between the operator and the card provides a key for the encipherment of data between card and terminal to avoid eavesdropping and the key can also be used in a distance bounding algorithm to check the proximity of card and terminal and avoid “man in the middle” attacks.

In one or more embodiments, we use the DDA key on the card to establish a symmetric key, and we store that key on the card for future use. The terminal decides whether to use the mechanism or not; for example a transport infrastructure could establish a key which it then used for subsequent transactions (for example, for the day, the week, the next year, indefinitely, and so on). If the key is used, reading of records can be bypassed, and instead of CDA, an additional MAC is formed on the response to the genAC command, using the symmetric key, so that the terminal can verify the card's authenticity.

Below are exemplary mechanisms that may be used to implement one or more inventive techniques:
1. Include a fixed card ID (may be PAN, may be pseudo random, may be just a different ID) in PPSE FCI response (or in FCI of Payment Application or in GPO response, but earlier in the transaction is believed to be better).
2. Include request for a scheme ID in PDOL
3. In GPO, if scheme ID is zero, symmetric key functionality need not be used. Otherwise, the card checks in a limited-size persistent data store for a matching keylD and key. In the GPO response, the card returns an extra data item with the keylD when the scheme ID is not zero.
4. The terminal examines the keylD. If this is not acceptable (old key, broken previous transaction, no key yet allocated), it reads terminal file records as normal to yield the ICC PK. It uses that to encipher keylD and a card-specific symmetric key and returns it to the card with a suitable command.
5. The terminal, if it wishes to use the new mechanism, then requests genAC with the extra MAC option.

Acronyms used hereinabove include: PAN—Primary Account Number; FCI—File Control Information; GPO—Get Processing Options; PDOL—Processing Data Objects List; ICC PK—Integrated Circuit Card Public Key; MAC—Message Authentication Code; and POS—Point of Sale. All of these are defined in the EMV standard. PPSE has been defined above. Card ID, Key ID, and Scheme ID are terms introduced here, with meaning apparent from the usage.

On an initial transaction to set up a key, the recovery of the ICC PK can proceed in parallel with READ RECORDS. This happens once per key change period per transit authority.

On subsequent transactions, the terminal obtains card ID from PPSE FCI data, identifies itself to the card in the GPO command, realizes that the card had a shared key in the response to GPO, and proceeds directly to genAC with the new MAC option. This is quick for the terminal to check and efficient for the card to generate.

In terms of overhead for normal POS transactions, the response to the PPSE contains about 10 bytes of extra data (at a cost of less than about 1 ms). The PDOL requests a tag that it did not know (which would be filled with zeros). The cost again is less than about 1 ms. The rest of the transaction proceeds as normal. By way of explanation, a normal retail POS would not have a transit operator ID to give the card and would not understand the card's request for it. Such a request is normally in the form of a defined “Tag.” Data items are defined by tag/length/value format. The card would return the tag and length for an operator ID. The basic rule in EMV is “if you do not understand a tag, fill that data item with zeros.” Therefore a normal retail POS terminal would not recognize the special tag and would return zeros to the card whereas a transit terminal would return the operator specific (non zero) value.

One exemplary manner of implementing inventive techniques is to modify the PAYPASS M/CHIP® specification as follows:
1. Personalize an ID in FCI of PPSE
2. Include a new tag in PDOL. Include logic to look up an entry in key store for scheme ID and return it if found in GPO response
3. Include command to recover symmetric key and store it.
4. Include new option to genAC to MAC response data with key selected in GPO command and append MAC to genAC response. Include a bit in CVR to indicate additional MAC method used.

In one or more instances of the invention, the issuer and acquirer never get to see the transit keys. The transit operator can choose how to perform their own key management, changing as frequently or infrequently as they wish. Key management is resilient to loss of a transit master key as keys can be changed. A given transit operator can choose to use the new method or not, and can choose to use CDA or not. Full card risk management can still be used. The exemplary inventive techniques set forth herein can be extended to contactless magnetic stripe cards, but note that in such a case, card risk management is absent. Magnetic stripe transactions using inventive techniques will be slightly faster than normal magnetic stripe transactions, as there is no need for READ RECORD.

It will be appreciated that one advantage of one or more embodiments of the invention is that, having established a trusted symmetric key once, we avoid the need for READ RECORDS (and parsing the responses thereto), and we replace the asymmetric signature with a symmetric one.

In view of the preceding description of a specific exemplary implementation of one or more aspects of the invention, it will be appreciated that, in general terms, an exemplary method of using a device conforming to a payment standard (such as, by way of example and not limitation, an EMV PAYPASS M/CHIP® card) to control access to at least a first facility (for example, one or more transit systems) can include the step of facilitating secure establishment of a key associated with a first facility identifier, shared between the device and an operator of the first facility, via a key management infrastructure of a payment system operating according to the payment standard. The method can also include facilitating controlling access to the first facility, via the device, using the key associated with the first facility identifier, substantially without reference to an issuer of the device and substantially without use of asymmetric keys of the device.

Thus, in one or more embodiments, we detect that an operator key, for a given operator, does not exist on the given card; we use the payment public key to establish an operator key; and we use the MAC for verification in transactions. In one or more embodiments, the steps take place within a standard payment transaction flow, providing a reduced transaction time as discussed elsewhere herein.

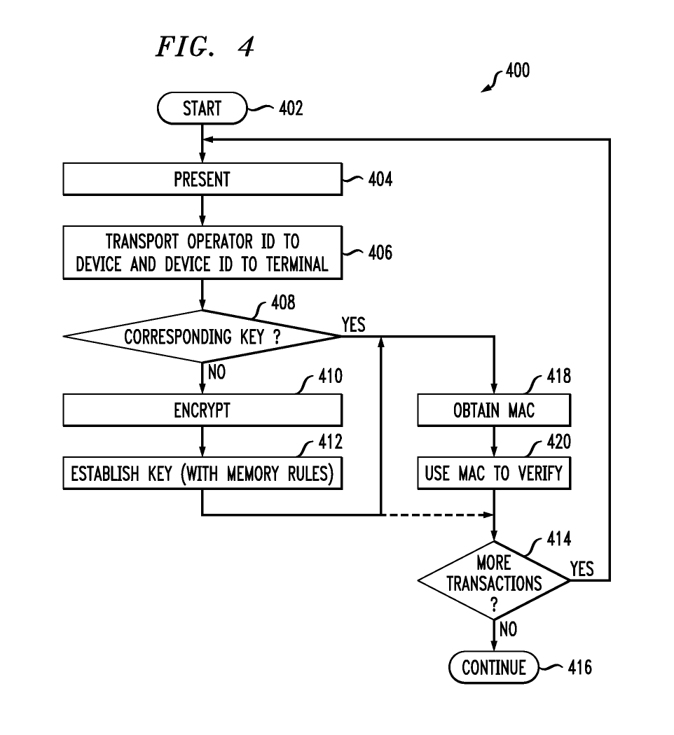

Reference should now be had to FIG. 4, which depicts a flow chart 400 of exemplary method steps, according to an aspect of the invention. After beginning at block 402, at 404, presentation of the device to a first terminal associated with the first facility is facilitated, within a first transaction substantially in accordance with the payment standard. In block 406, we facilitate the device obtaining from the first terminal a first facility identifier (for example, a transport operator ID for a first transit system). In decision block 408, we facilitate determining whether the device has the key associated with the first facility identifier already stored thereon (it will be appreciated that such key can have come from any terminal associated with the first transit system). Facilitating a device ID being sent from the device to the terminal will be discussed below.

As per the “NO” branch of block 408, responsive to the determining step 408 indicating that the device does not have the key associated with the first facility identifier already stored thereon, at block 410, we facilitate establishing (in some instances, encrypting) a first symmetric key with a public key of the device. In one or more embodiments, this is the payment public key, and thus, we are using the payment system's public key infrastructure to put a non payment key onto the card (or other device). Note that in some instances, after step 412, processing flow could proceed to steps 418 and 420 (solid line), while in other instances, processing flow could proceed to block 414 (dashed line). That is, a transport operator could choose (or not choose) to perform steps 418 and 420 upon the first presentation of the card in the system.

Still following the “NO” branch of block 408, at step 412, we establish the key associated with the first facility identifier with the device using the payment system card public key of the device. In one or more embodiments, the key associated with the first facility identifier is a card level master key diversified by the transport operator from a transport master key using the card identity. In this approach, the card implementation employs the card level key to create a session key from the card master key for each transaction. The use of memory rules, in the case where there is not enough space to store the key on the card, will be discussed below.

It will be appreciated that steps 404-412 represent one specific way of implementing the aforementioned general step of facilitating secure establishment of a key associated with a first facility identifier, shared between the device and an operator of the first facility, via a key management infrastructure of a payment system operating according to the payment standard (typically when presenting the card or other device to a first transit system for the first time-no stored key thus being present yet).

We now consider the “YES” branch of block 408—for example, the case where we present the card to the first transit system for the second time—now there is a stored key for the first transit system. This can correspond to a case where we decide in block 414 (discussed below) that another transaction is to be done (in this case, with the same facility). At block 404, we facilitate presentation of the device to a second terminal associated with the first facility (the second terminal could be same as or different from the first terminal), within a second transaction substantially in accordance with the payment standard. At block 406, we facilitate the device obtaining from the second terminal the first facility identifier (for example, transport operator ID for the first transit system). At block 408, we facilitate determining whether the device has the key associated with the first facility identifier already stored thereon. As noted, we are now considering the “YES” branch of block 408. Thus, responsive to the determining step 408 indicating that the device does indeed have the key associated with the first facility identifier already stored thereon, we move to block 418 (facilitating the second terminal obtaining from the device a message authentication cryptogram (MAC) for a payment transaction employing the key associated with the first facility identifier). In one or more instances, control then flows to block 420, where we facilitate usage of the message authentication cryptogram employing the key associated with the first facility identifier for verification purposes, substantially without use of conventional asymmetric cryptography techniques (in essence, the MAC enables the terminal to verify the card and the transaction data/cryptograms). It will be appreciated that steps 404-418 (and in one or more cases, 420), as just described for the second (and subsequent) presentations of the card to the first transit system, with the key for the first transit system stored on the card, represent one specific manner of carrying out the general step of facilitating controlling access to the first facility, via the device, using the key associated with the first facility identifier, substantially without reference to an issuer of the device and substantially without use of asymmetric keys of the device, as set forth above.

It should be noted for completeness at this point that in the first transaction, we could also facilitate the first terminal obtaining a MAC for verification purposes.

As discussed above, in one or more forms of the invention, provision of a device identifier from the device to the terminal is facilitated. This is indicated by the terminology “and device ID to terminal” in block 406—refer also to the discussion of step 302, annotated with a single star in FIG. 3, as set forth above.

Regardless of whether we have followed the “YES” or “NO” branches of block 408, at block 414, we determine whether more transactions are to be performed (with the first transit system, or a different system). If the answer is “YES,” we start over again at step 404. If the answer is “NO,” processing continues at block 416. It will thus be appreciated that, at a high level, in the case where block 414 yields a “YES” and the additional transaction(s) are to be with a new system without a stored key, in general terms, we perform the additional step of facilitating secure establishment of a key associated with a second facility identifier, shared between the device and an operator of a second facility, via the key management infrastructure of the payment system operating according to the payment standard. We also perform the additional step of facilitating controlling access to the second facility, via the device, using the key associated with the second facility identifier, substantially without reference to the issuer of the device and substantially without use of the asymmetric keys of the device.

In one or more embodiments of the invention, upon presenting the card or other device to a new transit system, for which a key has not yet been stored, we can repeat the detailed steps described in FIG. 4. Thus, at (repeated) step 404, we facilitate presentation of the device to a third terminal associated with a second facility, within a third transaction substantially in accordance with the payment standard; facilitate the device obtaining, from the third terminal, a second facility identifier (for example, a second transport operator ID), by repeating step 406; and facilitate determining whether the device has a key associated with the second facility identifier already stored thereon, by repeating step 408. Responsive to the determining step 408 indicating that the device does not have the key associated with the second facility identifier already stored thereon, as per the “NO” branch of repeated step 408, we facilitate establishing (in some instances, encrypting) a second symmetric key with the public key of the device, as per block 410 (this can be the same public key as used in the transactions with the first transit system—it is the card's payment systems offline public key being used to secretly transfer a non payment system key). Further, we facilitate establishing the key associated with the second facility identifier with the device using the just-mentioned public key of the device, as at (repeated) block 412. In one or more embodiments, this session key is the unique key for the second operator ID—the transport operator may choose to have it be unique for the operator ID, but in one or more instances, we diversify it on the card ID from a second operator master key.

When we present the card to the second transit system for the second time, such that there is now a stored key for the second system, the detailed steps of FIG. 4 may be repeated. At (repeated) block 404, we facilitate presentation of the device to a fourth terminal associated with the second facility (this could be the same or a different terminal as the third terminal), within a fourth transaction substantially configured in accordance with the payment standard. At (repeated) block 406, we facilitate the device obtaining from the fourth terminal the second facility identifier (for example, second transport operator ID). (Just as discussed above, in block 406, in one or more embodiments, we facilitate provision of the device identifier from the device to the fourth terminal.) At (repeated) block 408, we facilitate determining whether the device has the key associated with the second facility identifier already stored thereon. At (repeated) block 418 (having followed the “YES” branch of block 408), responsive to the (repeated) determining step 408 indicating that the device does have the key associated with the second facility identifier already stored thereon, we facilitate the fourth terminal obtaining from the device a message authentication cryptogram (MAC) employing the key associated with the second facility identifier.

It will be appreciated that the processes can be described can be repeated as often as desired for the same or different transit systems. The card or other device may have limited key storage memory capacity available for storing keys, and at some point, the memory may be full. In this case, one or more rules can be applied to determine which given one of a plurality of previously-stored keys is to be deleted to address the key storage capacity of the device being exceeded. A non-limiting example is to delete the oldest key (that is, the one that was last used the longest time in the past among all the stored keys). Where the key for a given transit operator has been deleted, the process can simply be repeated when the user rides on that system again, to restore the old key or establish a new key for that system. For example, a user might use his or her card, in chronological order, in London, Paris, New York, Berlin, and Tokyo. In this example, the use in Tokyo deletes the London key. Upon return to London, we re-load the London key (which deletes Paris, and so on).

In some instances, the established session key could have an identifier communicated from the device to the terminal (or vice versa) to enable the key to be replaced if the identifiers do not match—to recover from failed transactions, etc. For example, when the card replies to the GPO command in step 306, it indicates the version number of the key. This is an operator provided management data item that the operator can use to recognize the ‘version’ of the key. Thus, in such instances, additional steps can include facilitating establishing an identifier for the key associated with the first facility identifier; facilitating providing the identifier for the key associated with the first facility identifier from the device to a given terminal of the first facility; facilitating detecting whether the identifier for the key associated with the first facility identifier indicates that the key associated with the first facility identifier is current; and responsive to determining that the key associated with the first facility identifier is not current, facilitating replacement of the key associated with the first facility identifier (if the key is current, flow can proceed as normal).

In some instances, an additional method step can include performing a distance-bounding check to detect man in the middle fraud, the distance bounding check being performed using the key associated with the first facility identifier. Another possible step includes securing data storage, for at least one of confidentiality and integrity, via the key associated with the first facility identifier.

### EXAMPLE

The following table summarizes the amount of time a number of different transactions take in a non-limiting embodiment of the invention, it being understood that other embodiments of the invention might give different results:

| Transaction | Time (ms) |
|---|---|
| A retail POS transaction (SDA) | 335 |
| A retail POS transaction (CDA) | 493 |
| An initial session key SDA transaction | 455 |
| An initial session key CDA transaction | 613 |
| Subsequent session key transactions | 214 |

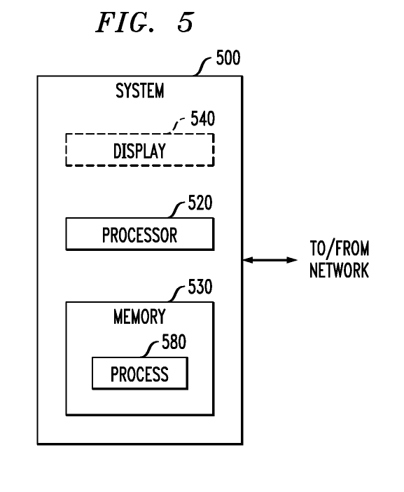

The invention can employ hardware and/or software aspects. Software includes but is not limited to firmware, resident software, microcode, etc. Software might be employed, for example, in connection with a terminal 122, 124, 126, 134, 206, 208. Firmware might be employed, for example, in connection with payment devices such as cards 102, 112, 1302. FIG. 5 is a block diagram of a system 500 that can implement part or all of one or more aspects or processes of the invention. As shown in FIG. 5, memory 530 configures the processor 520 (which could correspond, for example, to processor portions 106, 116) to implement one or more aspects of the methods, steps, and functions disclosed herein (collectively, shown as process 580 in FIG. 5). The memory 530 could be distributed or local and the processor 520 could be distributed or singular. The memory 530 could be implemented as an electrical, magnetic or optical memory, or any combination of these or other types of storage devices (including memory portions as described above with respect to cards 102, 112). It should be noted that if distributed processors are employed, each distributed processor that makes up processor 520 generally contains its own addressable memory space. It should also be noted that some or all of computer system 500 can be incorporated into an application-specific or general-use integrated circuit. For example, one or more method steps could be implemented in hardware in an ASIC rather than using firmware. Display 540 is representative of a variety of possible input/output devices.

### System and Article of Manufacture Details

As is known in the art, part or all of one or more aspects of the methods and apparatus discussed herein may be distributed as an article of manufacture that itself comprises a computer readable medium having computer readable code means embodied thereon. The computer readable program code means is operable, in conjunction with a computer system, to carry out all or some of the steps to perform the methods or create the apparatuses discussed herein. The computer readable medium may be a recordable medium (for example, floppy disks, hard drives, compact disks, EEPROMs, or memory cards) or may be a transmission medium (for example, a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk.

The computer systems and servers described herein each contain a memory that will configure associated processors to implement the methods, steps, and functions disclosed herein. Such methods, steps, and functions can be carried out, for example, by processing capability on elements 102, 112, 142, 122, 124, 126, 134, 140, 206, 208, or by any combination of the foregoing. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

Thus, elements of one or more embodiments of the invention, such as, for example, the aforementioned terminals 122, 124, 126, 134, 206, 208 or payment devices such as cards 102, 112, 1302 can make use of computer technology with appropriate instructions to implement method steps described herein. By way of further example, a terminal apparatus 122, 124, 126, 134, 206, 208 could include a communications module, an antenna coupled to the communications module, a memory, and at least one processor coupled to the memory and the communications module and operative to interrogate a contactless payment device (in lieu of the antenna and communications module, appropriate contacts and other elements could be provided to interrogate a contact payment device such as a contact card). One aspect of the invention includes a terminal suite (a group of terminals) for controlling access to a first facility (and optionally, additional terminal suites for controlling access to different facilities). The terminal suite(s) can include means for carrying out the various method steps, such as one or more memories coupled to one or more processors, operative to perform the method steps under control of software or firmware, or other combinations of hardware and/or software.

Accordingly, it will be appreciated that one or more embodiments of the invention can include a computer program comprising computer program code means adapted to perform one or all of the steps of any methods or claims set forth herein when such program is run on a computer, and that such program may be embodied on a computer readable medium. Further, one or more embodiments of the invention can include a computer comprising code adapted to cause the computer to carry out one or more steps of methods or claims set forth herein, together with one or more apparatus elements or features as depicted and described herein.

Although illustrative embodiments of the invention have been described herein with reference to the accompanying drawings, it is to be understood that the invention is not limited to those precise embodiments, and that various other changes and modifications may be made by one skilled in the art without departing from the scope or spirit of the invention.

1. (canceled)

2. A method of using a payment device to gain access to a facility, said method comprising the steps of:
providing, to said payment device, a symmetric key encrypted using a public key of a payment system, said symmetric key associated with a facility identifier of said facility;
detecting presentation of said payment device to a first terminal associated with said facility, within a first transaction, wherein said detection is performed subsequent to said providing said symmetric key to said payment device;
sending said facility identifier from said first terminal to said payment device upon said detection of presentation of said payment device;
receiving, from said payment device, a first verification of said payment device in the form of a cryptogram of a first transaction certificate, wherein said cryptogram of said first transaction certificate is decoded using said symmetric key associated with said facility identifier, and wherein said first transaction certificate is associated with a payment—type transaction on said payment system; and
granting access to said facility upon verification of said cryptogram of said first transaction certificate.

3. The method of claim 2, wherein said first transaction certificate is a second cryptogram, said method further comprising providing said first transaction certificate to said payment system.

4. The method of claim 3, wherein said first transaction certificate is secured from said facility, including said first terminal.

5. The method of claim 2, wherein granting access to said facility comprises controlling an access control product controlling physical access to said facility.

6. The method of claim 5, wherein said access control product is one of a turnstile and a wicket.

7. The method of claim 2, further comprising sharing said facility identifier among a plurality of terminals, including said first terminal, of said facility.

8. The method of claim 2, further comprising:
detecting presentation of said payment device to a second terminal associated with said facility, within a second transaction, wherein said detection is performed subsequent to said first transaction;
sending said facility identifier from said second terminal to said payment device;
receiving, from said payment device, a second verification of said payment device in the form of a cryptogram of a second transaction certificate, wherein said cryptogram of said second transaction certificate is decoded using said symmetric key associated with said facility identifier, and wherein said second transaction certificate is associated with said payment-type transaction on said payment system; and
granting exit from said facility upon verification of said cryptogram of said second transaction certificate.

9. The method of claim 8, further comprising billing an account associated with said payment device a fare calculated depending on a distance between said first terminal and said second terminal within said facility.

10. A method of using a payment device to gain access to a facility, said method comprising the steps of:
providing, to said payment device, a symmetric key encrypted with a public key of a payment system, said symmetric key associated with a facility identifier;
detecting presentation of said payment device to a terminal associated with said facility, within at least one transaction, wherein said detection is performed subsequent to providing said symmetric key to said payment device;
sending said facility identifier from said terminal to said payment device upon said detection of presentation of said payment device;
receiving, from said payment device, a first Message Authentication Cryptogram (MAC) around a transaction certificate, wherein said transaction certificate is associated with a payment-type transaction on said payment system;
verifying said payment device by decoding said first MAC using said symmetric key associated with said facility identifier; and
granting access to said facility upon verification of said first MAC.

11. The method of claim 10, wherein said transaction certificate is a second MAC, said method further comprising providing said transaction certificate to said payment system.

12. The method of claim 11, wherein said transaction certificate is secured from said facility by said second MAC.

13. The method of claim 10, wherein granting access to said facility comprises controlling an access control product controlling physical access to the facility.

14. The method of claim 13, wherein said access control product is one of a turnstile and a wicket.

15. The method of claim 10, further comprising sharing said facility identifier among a plurality of terminals, including said terminal, of said facility.

16. A terminal associated with a facility, said terminal comprising:
a first interface configured to receive a presentation of a payment device, within at least one transaction and to send a facility identifier to said payment device;
a second interface configured to receive, from said payment device, a first Message Authentication Cryptogram (MAC) around a transaction certificate, wherein said transaction certificate is associated with a payment-type transaction on a payment system;
a processor configured to verify said payment device by decoding said first MAC using a asymmetric key associated with said facility identifier; and
an access control product enabling physical access to said facility upon verification of said first MAC.

17. The terminal of claim 16, further comprising a third interface to a network of said facility comprising at least another terminal, wherein each terminal of said facility share a facility identifier.

18. The terminal of claim 16, further comprising a third interface configured to send said transaction certificate to said payment system, wherein said transaction certificate is a second MAC.
